(19) United States
(12) Patent Application Publication
(10) Pub. No.: US 2025/0104400 A1
(43) Pub. Date: Mar. 27, 2025

(54) Systems and Methods for Validated Training Sample Capture

(71) Applicant: ZEBRA TECHNOLOGIES CORPORATION, Lincolnshire, IL (US)

(72) Inventors: Neeta R. Joshi, Dallas, TX (US); David S. Koch, East Islip, NY (US); Dongqing Chen, East Setauket, NY (US); Gokul Vellingiri, Glenview, IL (US)

(21) Appl. No.: 18/371,558

(22) Filed: Sep. 22, 2023

(51) Int. Cl. G06V 10/774; G06K 7/14; G06V 10/25; G06V 10/764; G06V 20/70; G06V 30/10

(52) U.S. Cl. CPC G06V 10/774; G06K 7/1443; G06V 10/25; G06V 10/764; G06V 20/70; G06V 30/10

(57) ABSTRACT

A method includes: capturing an image of an item; generating, from the image, a region of interest bounding the item; obtaining, from the image, candidate label data corresponding to the item; receiving a validation input associated with the candidate label data; and in response to the validation input, generating a training sample for a classification model, the training sample including (i) the region of interest and (ii) label data corresponding to the item.

### BACKGROUND

Machine vision technologies may be employed to detect items in images collected in environments such as retail facilities. The deployment of such technologies may involve time-consuming collection of large volumes of training data, however.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a system for validated training data sample capture.

FIG. 2 is a flowchart of a method of validated training data sample capture.

FIG. 3 is a diagram illustrating an example performance of blocks 205, 210, and 215 of the method of FIG. 2.

FIG. 4 is a diagram illustrating an example performance of a first portion of block 220 of the method of FIG. 2.

FIG. 5 is a diagram illustrating an example performance of a second portion of block 220 of the method of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method, comprising: capturing an image of an item; generating, from the image, a region of interest bounding the item; obtaining, from the image, candidate label data corresponding to the item; receiving a validation input associated with the candidate label data; and in response to the validation input, generating a training sample for a classification model, the training sample including (i) the region of interest and (ii) label data corresponding to the item.

Additional examples disclosed herein are directed to a computing device, comprising: a sensor; and a processor configured to: capture an image of an item; generate, from the image, a region of interest bounding the item; obtain, from the image, candidate label data corresponding to the item; receive a validation input associated with the candidate label data; and in response to the validation input, generate a training sample for a classification model, the training sample including (i) the region of interest and (ii) label data corresponding to the item.

Further examples disclosed herein are directed to a method, comprising: capturing, at a computing device, an image of an item; determining a boundary containing the item in the image; obtaining, prior to capturing a further image, label data corresponding to the item; and generating a training sample for a classification model, the training sample including (i) the region of interest and (ii) label data corresponding to the item.

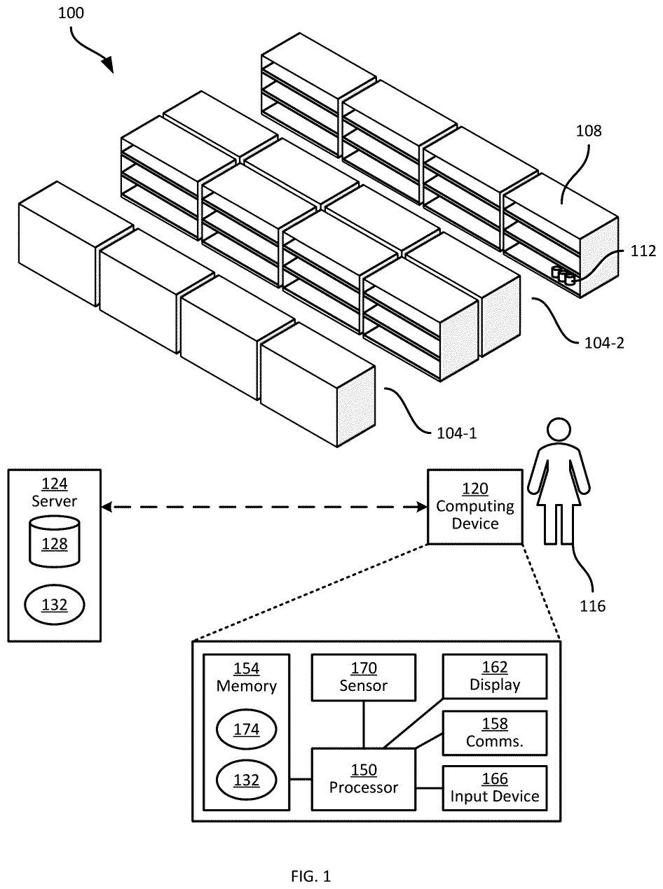

FIG. 1 illustrates a system 100 for validated training sample capture in a facility, such as a retail facility (e.g., a grocer), a warehouse, or the like. The facility contains one or more aisles 104-1, 104-2 (also referred to collectively as aisles 104, or generically as an aisle 104; similar nomenclature may also be employed herein for other elements referred to by numbers with hyphenated suffixes). The aisles 104 can be formed, as in the illustrated example, by support structures such as shelf modules 108, each defining one or more support surfaces (e.g., shelves, peg boards, or the like) for supporting items 112 such as products available for purchase by customers of a retail facility. In other examples, the items 112 can be supported on a wide variety of other surfaces, such as tables, conveyors, and the like. In further examples, the items 112 need not be on support surfaces, and can be suspended or held, e.g., by human staff in the facility, by transporters such as forklifts, drones, or the like. In further examples, the items 112 may be self-propelled, e.g., piloted or autonomous vehicles such as drones or the like. The system 100 can be deployed in a wide variety of other facilities, including manufacturing facilities, healthcare facilities, and the like.

The items 112 can be retrieved from the support structures, e.g., for purchase by customers of the facility, and/or by staff of the facility such as a worker 116 to fill orders for the items placed online or the like. The facility may contain a large variety of types of items, e.g., thousands or tens of thousands of distinct stock keeping units (SKUs). A SKU can be represented by an alphanumeric code that uniquely identifies items 112 of a given type. As will be understood, the facility can contain multiple instances of items of a given type (e.g., multiple substantially identical items with the same SKU). Retrieving particular types of items 112, e.g., by the worker 116 to fulfill an online order can therefore involve locating a selection of item types among the potentially significant number of types of items 112 in the facility.

To assist in locating items 112 for order fulfillment, and/or to assist is performing other stock-keeping tasks such as locating misplaced items and the like, the system 100 includes a computing device 120, such as a mobile computing device (e.g., a tablet computer, a handheld computer, a wearable computer, a smart phone, or the like). The computing device 120 can be operated by the worker 116 to perform, among other functions, an item recognition function. For example, the computing device 120 can be configured to capture an image of a support structure 108, such that the image depicts a plurality of the items 112. The computing device can then be configured to process the image, e.g., by executing a classification model, to detect items 112 and classify the items 112. For example, the output of the classification model can include a bounding box indicating the position of an item 112 in the image, and item recognition output such as a SKU or other identifier corresponding to the item 112, and/or an item description such as a product name and quantity (e.g., a weight, volume, or the like). Substantially real-time item recognition implemented by the device 120 can facilitate the retrieval of specific items 112 from the support structures 108 by the worker 116, e.g., by highlighting those items on the image captured by the device 120.

The classification model mentioned above can be based on a suitable object detection algorithm, such as a substantially real-time object detector implementing one or more convolutional neural networks (CNN). An example classification model is the You Only Look Once (YOLO) classifier. Implementation of such classification models involves collecting and processing a volume of training data, such as images of each item 112 labelled with identifiers (e.g., SKUs) and descriptions (e.g., names and quantities). The training process involves determining and storing (e.g., in the form of node weights and other parameters of the classification model) correlations between image features and specific item types.

Training data, once collected, can be provided to a computing device such as a server 124 (or, in some instances, the computing device 120 itself). The server 124 can store samples of training data in a repository 128, and can execute a training process (e.g., at least once, and in some examples periodically as further training data samples are collected) to generate a classification model 132, also referred to herein as a classifier 132. The classification model 132 can be deployed to computing devices such as the device 120, via any suitable communications networks (e.g., including either or both of wide-area networks and local-area networks).

The number of distinct types of items 112 in the facility can complicate collection of training data. For example, computer-generated renderings of the items 112 (e.g., based on three-dimensional models of the items 112) may insufficiently resemble the actual items 112, and therefore be unsuitable for use in training data. Images (e.g., photographs) of the items 112 taken under controlled conditions distinct from the facility may also be unsuitable, as the immediate physical surroundings of the items 112 may differ from the facility, and lighting and other conditions may vary. Images of the items 112 captured in the facility may therefore be preferred for training data. Labelling such images to generate samples of training data, however, can be time-consuming and error-prone. For example, a batch of images can be collected within the facility, and later annotated manually. Such manual annotation may, however, result in errors due to image artifacts, or certain images may not be labelled because sufficient labelling information is not readily visible in the images themselves.

The device 120 is therefore configured, as discussed below, to implement a process for generating training data samples that are collected and validated substantially in real-time, while the items 112 are readily available in the event that sample generation involves obtaining corrected or otherwise updated label data from a source distinct from the captured images. The validated training data samples can be stored at the device 120, and/or transmitted from the device 120 to the server 124 for storage in the repository 128 and training or re-training of the classifier 132. The server 124 can subsequently deploy the re-trained classifier 132 to the device 120 (and any other suitable computing devices).

Certain internal components of the device 120 are illustrated in FIG. 1. The device 120 includes a processor 150 (e.g., a central processing unit (CPU), graphics processing unit (GPU), and/or other suitable control circuitry, microcontroller, or the like), interconnected with a non-transitory computer readable storage medium, such as a memory 154. The memory 154 includes a suitable combination of volatile memory (e.g. Random Access Memory or RAM) and non-volatile memory (e.g. read only memory or ROM, Electrically Erasable Programmable Read Only Memory or EEPROM, flash memory). The memory 154 can store computer-readable instructions, execution of which by the processor 150 configures the processor 150 to perform various functions in conjunction with certain other components of the computing device 120. The computing device 120 also includes a communications interface 158 enabling the device 120 to exchange data with other computing devices such as the server 124, e.g. via a wireless local area network deployed in the facility, a combination of local and wide-area networks, and the like.

The device 120 can also include a display 162 and/or other suitable output device, such as a speaker. The device 120 can further include an input device 166 such as a touch panel integrated with the display 162, keypad, a microphone, and/or other suitable inputs. The input device 166 enables the device 120 to receive input, e.g., from the worker 116 or other operators of the device 120. The device 120 can further include a sensor 170, such as an image sensor (e.g., a camera implemented via a metal-oxide-semiconductor-based sensor panel and optics assembly). In some examples, the device 120 can include additional sensors, such as a scanner assembly distinct from the sensor 170. The scanner assembly can include a further image sensor and associated microcontrollers or other suitable control circuitry and/or firmware to capture images and detect and decode barcodes (e.g., one-dimensional and two-dimensional barcodes) from the images. In other examples, the device 120 can implement the functionality of such a scanner assembly using the sensor 170.

The instructions stored in the memory 154 include, in this example, a training data collection application 174 that, when executed by the processor 150, configures the device 120 to capture and validate training data samples for training the classification model 132. The memory 154 can also store the classifier 132, e.g., as a component of the application 174 or as a separate application. The classifier 132 can be deployed to the device 120 from the server 124, in some examples. The device 120 and the application 174 may be referred to in the discussion below as being configured to perform various actions. It will be understood that such references indicate that the device 120 is configured to perform those actions via execution of the application 174 by the processor 150. In some examples, the application 174 can be implemented via dedicated control hardware, such as an application-specific integrated circuit (ASIC) or the like.

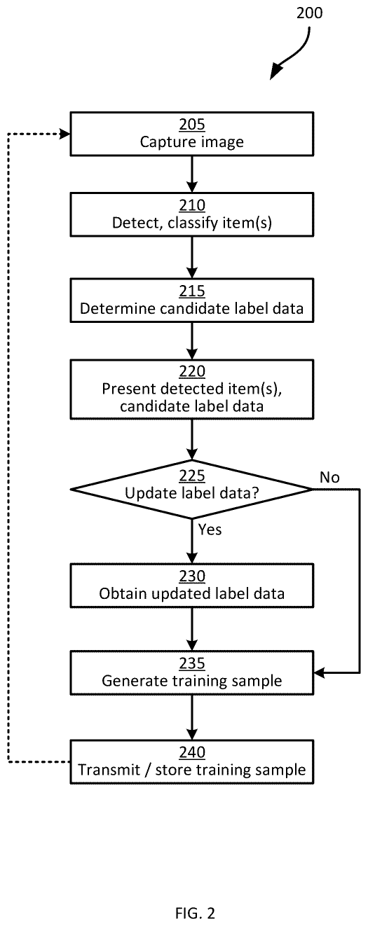

Turning to FIG. 2, a method 200 of collecting validated training data samples is illustrated. The method 200 is described below in conjunction with its performance by the device 120, via execution of the application 174 by the processor 150. As will be understood from the discussion below, the method 200 can also be implemented by other computing devices with at least some of the operational capabilities of the device 120.

At block 205, the device 120 is configured to capture an image of an item 112 disposed on a support structure 108. For example, the device 120 can be positioned relative to the support structure 108 such that at least a portion of the support structure 108 is within a field of view of the sensor 170, and the sensor 170 can be controlled to capture the image. The image captured at block 205 can depict as few as a single item 112, or a plurality of items 112. The number of items 112 depicted in the image from block 205 can vary depending on the size of the items 112 and any image quality requirements of the classifier 132. For example, an image of one item 112 with a low resolution may provide insufficient detail to resolve features of the items 112, and may therefore be unsuitable for a training sample. For example, an image of an item 112 containing at least fifty thousand pixels (e.g., two hundred and fifty by two hundred pixels) may be suitable for use in a training sample. The number of items 112 represented in the image from block 205 can therefore depend on the resolution of the sensor 170. For example, a ten-megapixel sensor 170 may capture an image accommodating over one hundred items 112 while still capturing sufficient detail to use sub-images of each item 112 for training samples.

At block 210, the device 120 is configured to detect at least one region of interest bounding an item 112 in the image from block 205. For example, the device 120 can be configured to execute the classifier 132 to detect objects in the image from block 205. The classifier 132 can be configured to detect both items 112, and barcodes, such as those appearing on labels affixed to the support structures 108 (e.g., on shelf edges). In other examples, the detection of barcodes in the image from block 205 can be performed by a detector separate from the classifier 132.

The detection of each item 112 at block 210 includes determining a boundary, such as a rectangular bounding box, dividing the portion of the image containing the item 112 from the remainder of the image. The performance of block 210 can therefore involve generating a plurality of bounding boxes, each defined by pixel coordinates within the image from block 205, and each corresponding to a distinct item 112 (although certain items 112 may be of the same type). In some examples, the device 120 can evaluate the regions of interest to determine whether they are sufficiently large to serve as training samples. For example, the device 120 can determine whether the area (in pixels) of each region of interest satisfies a threshold. When the determination is negative for any region of interest, the device 120 can generate a warning or other notification (e.g., on the display 162) prompting the operator the device 120 to capture a further image to replace the image from block 205.

In some examples, the device 120 can also, at block 210, classify the items 112 via execution of the classifier 132. The device 120 can extract each boundary detected at block 210 as a sub-image, and process the sub-image to identify the item 112 shown therein. The output of classification includes item recognition data, such as a SKU or other suitable item identifier, and/or an item description. In this example, the item description includes an item name (e.g., the brand name and product name), and a quantity (e.g., a weight, volume, or count corresponding to the item 112). The item recognition data also includes a confidence level, indicating a likelihood (as assessed by the classifier 132) that the product identifier and description are correct. In some examples, the device 120 may produce no item recognition data for a given region of interest, e.g., if the confidence level is below a threshold (e.g., 30%, although various other thresholds can be applied). Such low confidence can result from the repository 128 lacking training samples, or including few training samples, for the item shown in the region of interest. That is, the classifier 132 may not yet have been trained to recognize the item 112 shown in the region of interest.

At block 215, the device 120 is configured to determine candidate label data from the image captured at block 205. The candidate label data is derived independently from the classifier 132. That is, the candidate label data is obtained at block 215 by performing other processes on the image from block 205 than those performed via execution of the classifier 132. In some instances, however, the candidate label data may match the item recognition data.

The nature of the candidate label data determined at block 215 is dependent on the output of the classifier 132. In this example, the classifier 132 outputs an item identifier (e.g., a SKU), and an item description (e.g., a name and quantity). Therefore, to determine the candidate label data at block 215, the device 120 can determine an identifier such as a SKU corresponding to each region of interest, and a description corresponding to each region of interest.

As noted above, the device 120 can detect barcodes, such as those on shelf labels and/or on the items 112 themselves, at block 210. Determining an identifier such as a SKU for a region of interest includes, in this example, determining associations between barcodes and items 112, and decoding a barcode associated with a given region of interest. For example, for a given region of interest, the device 120 can determine which detected barcode in the image from block 205 is closest to the region of interest according to predefined association criteria. For example, because shelf labels generally appear below and to the left of corresponding items, the device 120 can be configured to select, from a plurality of detected barcodes in the image, the first barcode below and to the left of the region of interest. The vertical distance between the region of interest and the barcode may take precedence over the horizontal distance between the region of interest and the barcode.

Determining candidate label data at block 215 can include, in addition to or instead of determining an identifier from a barcode, detecting text within a region of interest and performing optical character recognition (OCR) on the detected text. The device 120 can, for example, be configured to detect and interpret any text appearing in the region of interest, and can then filter the output of such detection and interpretation for text that is likely to correspond to a product description. In the case of a product name and quantity, for example, the device 120 can select decoded text with a font above a threshold height and/or relative to the height and/or width of the region of interest. In the case of a quantity, the device 120 can select decoded text containing numerical characters, and can also in some examples apply positional criteria (e.g., numerical characters within a threshold distance of the lower edge of the item).

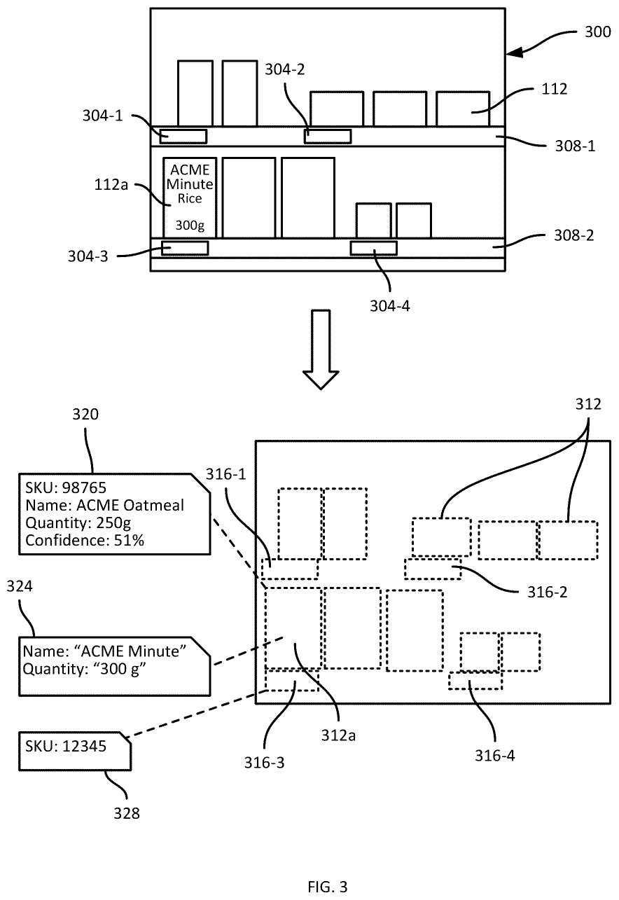

Turning to FIG. 3, an example performance of blocks 205, 210, and 215 is illustrated. FIG. 3 illustrates an image 300 captured by the device 120 (e.g., via the sensor 170). The image 300 depicts a plurality of items 112 disposed on support structures such as the shelf modules 108. The image 300 also depicts shelf labels 304-1, 304-2, 304-3 and 304-4, disposed on shelf edges 308-1 and 308-2. The shelf labels 304 may include barcodes encoding SKUs or other item identifiers. The items 112 are illustrated as boundaries for simplicity, but it will be understood that each item 112 includes text, graphics and the like thereon. For example, an item 112a is shown including the product name “ACME Minute Rice” and the quantity “300 g”, e.g., printed on a face of a box. Some item types may appear more than once in the image, e.g., if multiple facings for a given item are placed on a shelf. For example, the image 300 depicts two additional items of the same type as the item 112a, immediately to the right of the item 112a.

From the image 300, at block 210 the device 120 is configured to detect regions of interest bounding each item 112. The device 120 detects, in this example, a plurality of regions of interest 312, including a region of interest 312a corresponding to the item 112a. The device 120 can also detect secondary regions of interest 316-1, 316-2, 316-3, and 316-4 containing the barcodes on the labels 304 mentioned earlier, via the classifier 132 or a separate classifier configured to detect barcodes.

At block 210 the device 120 can also generate item recognition data 320, associated with the region of interest 312a. As will be understood, the device 120 can generate item recognition data for each of the regions of interest 312. The item recognition data 320 includes an item identifier such as the SKU “98765”, and an item description. In this example, the item description includes a name (e.g., “ACME Oatmeal”) and a quantity (e.g., “250 g”). As will be apparent from FIG. 3, the identifier and description in the item recognition data 320 are incorrect, e.g., because the classifier 132 has been trained with few samples of training data corresponding to the item 112a.

At block 215, the device 120 determines candidate label data including a candidate item description 324, derived via OCR of the text on the item 112, within the region of interest 312a. The candidate label data also includes a candidate identifier 328, such as a SKU decoded from the barcode within the secondary region of interest 316-3.

Returning to FIG. 2, at block 220, the device 120 is configured to present the detected items and candidate label data, e.g., on the display 162. In some examples, the device 120 can present the entire image 300 on the display 162, with the regions of interest highlighted or otherwise visually indicated. Upon receipt of a selection of a region of interest via the input device 166, the device 120 can present the selected region of interest in isolation on the display 162 (e.g., by zooming in on the image 300), and can then present the candidate label data.

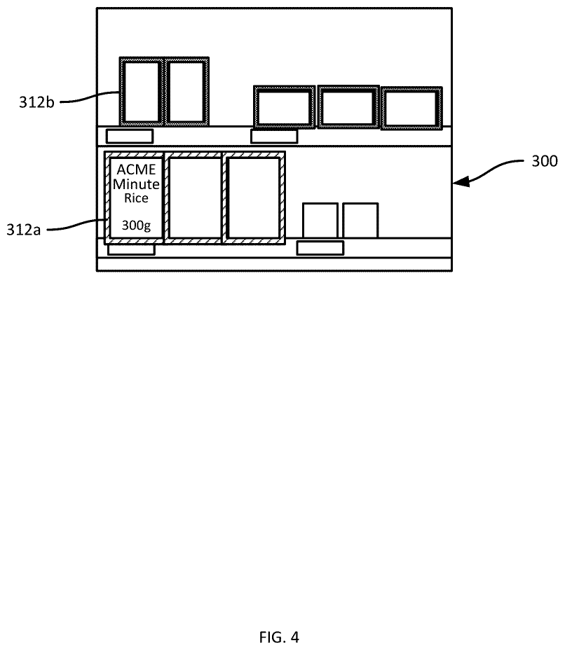

Turning to FIG. 4, the image 300 is shown, e.g., as presented at block 220. As shown in FIG. 4, certain regions of interest, such as the region of interest 312a, are presented with a first visual indicator, such as a color, shading, fill, or the like. The first visual indicator corresponds to regions of interest for which the confidence level obtained at block 210 was below a predetermined threshold (e.g., 70%, although a wide variety of other thresholds can also be used). Other regions of interest, such as a region of interest 312b, can be presented with a second visual indicator, indicating that the confidence level associated with those regions of interest exceeds the predetermined threshold. The visual indicators, in other words, can highlight items for which the collection of additional training data samples is desirable.

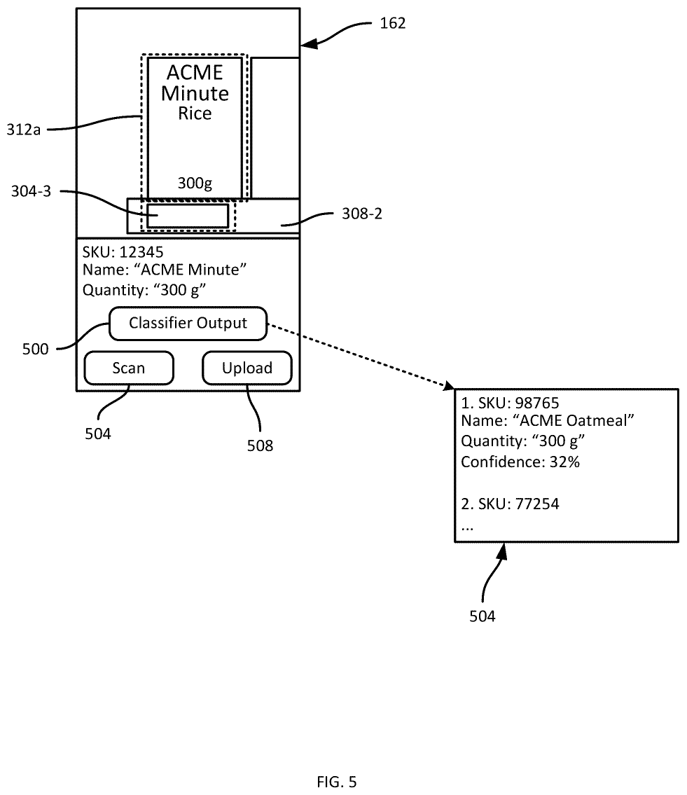

Also at block 220, in response to a selection of a region of interest from those shown in FIG. 4, e.g., via the input device 166, the device 120 can present the selected region of interest on the display 162 in magnified form, omitting some or all of the remainder of the image 300. For example, as shown in FIG. 5, the region of interest 312a, containing the item 112a, is shown on the display 162, as well as a portion of the shelf edge 308-2 and label 304-3. In addition, the device 120 presents the candidate label data including the description 324 and the identifier 328. In other examples, although not shown in FIG. 5, the item recognition data 320 can also be presented on the display 162 for comparison with the candidate label data.

In some examples, the device 120 can present a selectable element 500, selection of which causes the device 120 to present the item recognition output 320, as well as additional sets of item recognition output. For example, the classifier 132 may return multiple sets of item recognition data (e.g., the five sets with the highest confidence levels). The device can, in response to a selection of the element 500, present those multiple sets. In some cases, a lower-confidence recognition output may indicate the correct item, and that output can be selected for use as label data.

Returning to FIG. 2, at block 225 the device 120 is configured to determine whether to update the candidate label data presented at block 220. The determination at block 225 can include, for example, determining whether input data has been received via the input device 166, e.g., to edit the candidate label data.

When the determination at block 225 is affirmative, at block 230 the device 120 is configured to receive updated label data. For example, as shown in FIG. 3 and FIG. 5, the description 324 omits the word “rice”, e.g., because the size of the word was small enough to be filtered out at block 215. The worker 116 may therefore edit the description shown in FIG. 5 to provide the description “ACME Minute Rice”. In other examples, the item identifier may be missing (e.g., if the image 300 was not capture close enough to the label 304-3 to decode the barcode thereon) or incorrect (e.g., if the shelf label 304-3 is the incorrect label and does not match the item 112a). In such examples, the candidate identifier shown in FIG. 5 can be edited or replaced, either via text editing, or by performing a barcode scanning operation. For example, the worker 116 can select the element 504 to initiate a barcode scan, in order to scan a label on the item 112a itself, another shelf label, or the like. In further examples, the worker 116 can select the element 500 to present other sets of classifier output, and select one of those sets to replace the candidate label data. The candidate label data can be further edited as necessary, e.g., via the input device 166.

When the determination at block 225 is negative, the device 120 proceeds directly to block 235, bypassing block 230. For example, the device 120 can receive a validation input at block 225 that either indicates editing or replacement of the candidate label data (in which case the device 120 proceeds to block 230), or that indicates acceptance of the current label data (whether edited or original). A validation input indicating acceptance can include selection of an “upload” element 508 shown in FIG. 5.

At block 235, the device 120 is configured to generate a training sample for the classifier 132. The training sample includes the portion of the image 300 within the region of interest (e.g., the region of interest 312a, in this example), as well as the validated label data. The validated label data is either the candidate label data, in the case of an affirmative determination at block 225, or the updated label data from block 230. The training sample, in other words, is an annotated or labelled image of an item. The label associated with the image of the item indicates the identifier (e.g., the SKU) of the item, as well as the description (e.g., a name and a quantity) of the item. In other examples, the description may be omitted, e.g., if the classifier 132 outputs only identifiers, or the identifier may be omitted if the classifier 132 outputs only descriptions.

At block 240, the device 120 is configured to transmit the sample from block 235 to the server 124 for storage in the repository 128 and training of the classifier 132, and/or to store the sample locally, in the memory 154. The above process can be repeated for any or all of the remaining regions of interest in the image 300.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
capturing an image of an item;
generating, from the image, a region of interest bounding the item;
obtaining, from the image, candidate label data corresponding to the item;
receiving a validation input associated with the candidate label data; and
in response to the validation input, generating a training sample for a classification model, the training sample including (i) the region of interest and (ii) label data corresponding to the item.

2. The method of claim 1, wherein obtaining the candidate label data includes at least one of:
detecting a barcode in the image and decoding the barcode, or
detecting text in the region of interest, and performing optical character recognition on the detected text.

3. The method of claim 2, wherein detecting the barcode includes determining that a position of the barcode in the image relative to the region of interest satisfies an association criterion.

4. The method of claim 1, wherein receiving the validation input includes at least one of:
receiving text defining a description of the item, or
controlling a sensor to scan a barcode associated with the item.

5. The method of claim 1, wherein the label data corresponding to the item includes at least one of:
at least a portion of the candidate label data, or
updated label data defined by the validation input.

6. The method of claim 1, further comprising:
in response to detecting the region of interest, executing the classification model to determine item recognition data corresponding to the item, the item recognition data including a confidence level; and
displaying the region of interest with a first visual attribute if the confidence level satisfies a threshold, or a second visual attribute if the confidence level does not satisfy the threshold.

7. The method of claim 6, further comprising:
via execution of the classification model, determining a plurality of sets of item recognition data with respective confidence levels;
wherein the validation input includes a selection of one of the sets of item recognition data.

8. A computing device, comprising:
a sensor; and
a processor configured to:
capture an image of an item;
generate, from the image, a region of interest bounding the item;
obtain, from the image, candidate label data corresponding to the item;
receive a validation input associated with the candidate label data; and
in response to the validation input, generate a training sample for a classification model, the training sample including (i) the region of interest and (ii) label data corresponding to the item.

9. The computing device of claim 8, wherein the processor is configured to obtain the candidate label data by at least one of:
detecting a barcode in the image and decoding the barcode, or
detecting text in the region of interest, and performing optical character recognition on the detected text.

10. The computing device of claim 9, wherein the processor is configured to detect the barcode by determining that a position of the barcode in the image relative to the region of interest satisfies an association criterion.

11. The computing device of claim 8, wherein the processor is configured to receive the validation input by at least one of:
receiving text defining a description of the item, or
controlling a sensor to scan a barcode associated with the item.

12. The computing device of claim 8, wherein the label data corresponding to the item includes at least one of:
at least a portion of the candidate label data, or
updated label data defined by the validation input.

13. The computing device of claim 8, wherein the processor is further configured to:
in response to detecting the region of interest, execute the classification model to determine item recognition data corresponding to the item, the item recognition data including a confidence level; and
display the region of interest with a first visual attribute if the confidence level satisfies a threshold, or a second visual attribute if the confidence level does not satisfy the threshold.

14. The computing device of claim 13, wherein the processor is further configured to:
via execution of the classification model, determine a plurality of sets of item recognition data with respective confidence levels;
wherein the validation input includes a selection of one of the sets of item recognition data.

15. A method, comprising:
capturing, at a computing device, an image of an item;
determining a boundary containing the item in the image;
obtaining, prior to capturing a further image, label data corresponding to the item; and
generating a training sample for a classification model, the training sample including (i) the boundary and (ii) label data corresponding to the item.

16. The method of claim 15, wherein obtaining the label data includes receiving input data at the computing device, the input data defining an identifier affixed to the item.
